(19) United States
(12) Patent Application Publication
(10) Pub. No.: US 2009/0155658 A1
(43) Pub. Date: Jun. 18, 2009

(54) ELECTRODE FOR POLYMER ELECTROLYTE FUEL CELL, MEMBRANE/ELECTRODE ASSEMBLY AND PROCESS FOR PRODUCING CATALYST LAYER

(75) Inventors: Seigo KOTERA, Tokyo (JP); Katsuya FUJII, Tokyo (JP); Ichiro TERADA, Tokyo (JP); Hiroshi UYAMA, Suita-shi (JP); Chie MATSUBARA, Suita-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Asahi Glass Company, Limited, Chiyoda-ku (JP)

(21) Appl. No.: 12/333,899

(22) Filed: Dec. 12, 2008

(30) Foreign Application Priority Data
Dec. 13, 2007 (JP) 2007-321772

(51) Int. Cl. H01M 4/92; H01M 8/10; H01M 4/88

(52) U.S. Cl. 429/30; 429/42; 502/101

(57) ABSTRACT

To provide an electrode for a polymer electrolyte membrane having high gas diffusion performance, a membrane/electrode assembly, and a process for producing a nonwoven structure for a catalyst layer, which can produce the membrane/electrode assembly inexpensively and easily.

The catalyst layer 11 of the electrode comprises a nonwoven structure of an ion-exchangeable fluoropolymer fiber, wherein the fiber diameter of the fiber is from 0.1 to 30 μm, and the bulk density of the nonwoven structure is from 0.1 to 1.1 g/cc. The nonwoven structure is produced by forming fiber from a fiber spinning stock solution containing the ion-exchangeable fluoropolymer by an electrical field fiber spinning method, followed by gathering the fiber. A catalyst is blended in the fiber spinning stock solution or is adhered on the nonwoven structure.

### BACKGROUND OF THE INVENTION

1. Field of the Invention

The present invention relates to an electrode for a polymer electrolyte fuel cell, a membrane/electrode assembly and a process for producing a catalyst layer.

2. Discussion of Background

As a polymer electrolyte fuel cell, one provided with a membrane/electrode assembly having a polymer electrolyte membrane disposed between two electrodes having catalyst layers, is known.

The polymer electrolyte fuel cell is required to satisfy an operation condition for high utilization of hydrogen and oxygen, a high energy efficiency and a high output density.

In order for the polymer electrolyte fuel cell to satisfy such requirements, gas diffusion performance in the catalyst layer plays a particularly important role among elements constituting the cell.

A conventional membrane/electrode assembly is produced, for example, by the following method:

(i) A method wherein a catalyst and an ion-exchangeable fluoropolymer are dissolved or dispersed in an alcohol solvent (e.g. ethanol), and such a liquid mixture is directly applied on a surface of a polymer electrolyte membrane to form a catalyst layer; or

(ii) a method wherein the above liquid mixture is applied on a substrate film to form a catalyst layer, and such a catalyst layer is transferred or bonded to a surface of a polymer electrolyte membrane.

However, with respect to the membrane/electrode assembly obtained by such a method, formation of fine pores in the catalyst layer is not sufficient, and the gas diffusive property is low. Therefore, when a polymer electrolyte fuel cell provided with such a membrane/electrode assembly is used at a high current density, decrease of an output voltage results.

The following process has been proposed, as a process for producing a membrane/electrode assembly having a catalyst layer with high gas diffusion.

(1) A process wherein a catalyst and an ion-exchangeable fluoropolymer are dispersed or dissolved in a solvent to obtain a liquid mixture, from which the solvent is removed for granulation to form particles having an average particle size of from 0.1 to 100 μm, followed by applying such particles on a surface of a polymer electrolyte membrane and by heating and pressure-bonding to form a catalyst layer (Patent Document 1); or

(2) a process wherein a catalyst and an ion-exchangeable fluoropolymer are added to a solvent containing an alcohol (e.g. ethanol) and a fluorinated alcohol to prepare a liquid mixture, and by using such a liquid mixture is used to form a catalyst layer (Patent Document 2).

However, even a catalyst layer formed by such a process (1) or (2) is not sufficient in gas diffusion performance. Further, the fluorinated alcohol is expensive as compared with an usual alcohol, and it needs to be recovered when it is evaporated by drying a coated film of the liquid mixture.

Patent Document 1: JP-A-2001-185163

Patent Document 2; JP-A-2002-110202

### SUMMARY OF THE INVENTION

The present invention provides an electrode for a polymer electrolyte fuel cell having a catalyst layer with high gas diffusive property, a membrane/electrode assembly and a process for producing such a catalyst layer inexpensively and easily.

The electrode for a polymer electrolyte fuel cell of the present invention is an electrode for a polymer electrolyte fuel cell having a catalyst layer, wherein the catalyst layer has a nonwoven structure of fiber containing an ion-exchangeable fluoropolymer and a catalyst, the fiber has a fiber diameter of from 0.1 to 30 μm, and the catalyst layer has a bulk density of from 0.1 to 1.1 g/cc.

The electrode for a polymer electrolyte fuel cell of the present invention is an electrode for a polymer electrolyte fuel cell having a catalyst layer, wherein the catalyst layer has a nonwoven structure of fiber containing an ion-exchangeable fluoropolymer, and a catalyst adhered on the fiber, the fiber has a fiber diameter of from 0.1 to 30 μm, and the catalyst layer has a bulk density of from 0.1 to 1.1 g/cc.

The electrode for a polymer electrolyte fuel cell of the present invention is an electrode for a polymer electrolyte fuel cell having a catalyst layer, wherein the catalyst layer has a nonwoven structure comprising fiber containing an ion-exchangeable fluoropolymer and a catalyst and fiber containing an ion-exchangeable polymer and no catalyst, the fiber having a fiber diameter of from 0.1 to 30 μm, and the catalyst layer has a bulk density of from 0.1 to 1.1 g/cc.

The ion-exchangeable fluoropolymer is preferably a copolymer having repeating units based on tetrafluoroethylene and repeating units represented by the following formula (1):

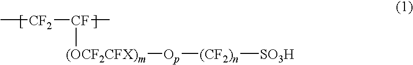

wherein X is a fluorine atom or a trifluoromethyl group, m is an integer of from 0 to 3, n is integer of from 1 to 12, and p is 0 or 1.

The ion-exchange capacity of the ion-exchangeable fluoropolymer is preferably from 1.1 to 1.8 meq/g dry resin.

The catalyst is a catalyst having platinum or a platinum alloy supported on a carbon carrier.

The membrane/electrode assembly for a polymer electrolyte fuel cell of the present invention comprises a cathode, an anode and a polymer electrolyte membrane disposed between them, wherein at least one of the cathode and anode is made of the above electrode of the present invention.

The process for producing a catalyst-containing nonwoven structure for a catalyst layer of an electrode for a polymer electrolyte fuel cell of the present invention, comprises producing a catalyst-containing nonwoven structure having a bulk density of from 0.1 to 1.1 g/cc and having fiber with a fiber diameter of from 0.1 to 30 μm gathered, from a stock solution for spinning containing an ion-exchangeable fluoropolymer and a catalyst, by an electrical field fiber spinning method.

The process for producing a catalyst-containing nonwoven structure for a catalyst layer of an electrode for a polymer electrolyte fuel cell of the present invention, comprises producing a catalyst-containing nonwoven structure having a bulk density of from 0.1 to 1.1 g/cc and having fiber with a fiber diameter of from 0.1 to 30 μm gathered, from a stock solution for spinning containing an ion-exchangeable fluoropolymer, by an electrical field fiber spinning method, and letting a catalyst be supported on the nonwoven structure.

The process for producing a catalyst-containing nonwoven structure for a catalyst layer of an electrode for a polymer electrolyte fuel cell of the present invention, comprises producing a catalyst-containing nonwoven structure having a bulk density of from 0.1 to 1.1 g/cc and having each fiber with a fiber diameter of from 0.1 to 30 μm gathered, by fiber-spinning from each of a stock solution for spinning containing an ion-exchangeable fluoropolymer and catalyst and a stock solution for spinning containing an ion-exchangeable fluoropolymer and no catalyst, by an electrical field fiber spinning method.

The stock solution for spinning preferably contains polyalkylene oxide or polyvinyl alcohol.

In the process for producing a catalyst-containing nonwoven structure for a catalyst layer of the present invention, as the stock solution for spinning, n types (n is an integer of at least 2) of stock solution for spinning are used, and when the stock solution for spinning are spun into fiber by an electrical field fiber spinning method, the following fiber spinning nozzle is preferably used:

a fiber spinning nozzle which has n flow paths, and one nozzle which discharges n types of fiber spinning solutions merged at the outlet end of the flow paths in a state of multiple layers.

In the process for producing a catalyst-containing nonwoven structure for a catalyst layer of the present invention, as the stock solution for spinning, n types (n is an integer of at least 2) of stock solution for spinning are used, and when the stock solution for spinning are spun into fiber by an electrical field fiber spinning method, the following fiber spinning nozzle is preferably used:

a fiber spinning nozzle having multiple nozzles wherein n number of nozzles having different diameters are located concentrically to form a flow path between the adjacent nozzles.

In the process for producing a catalyst-containing nonwoven structure for a catalyst layer of the present invention, the fiber is preferably formed on a polymer electrolyte membrane.

In the process for producing a catalyst-containing nonwoven structure for a catalyst layer of the present invention, the fiber is preferably formed on a sheet for a gas diffusion layer.

The electrode for a polymer electrolyte fuel cell of the present invention has a catalyst layer with high gas diffusive property. Therefore, a polymer electrolyte fuel cell provided with such an electrode can exhibit good characteristics even when it is operated at a high current density.

The membrane/electrode assembly for a polymer electrolyte fuel cell of the present invention has a catalyst layer with high gas diffusive property. Therefore, a polymer electrolyte fuel cell provided with such a membrane/electrode assembly can exhibit good characteristics even when it is operated at a high current density.

According to the process for producing a catalyst-containing nonwoven structure for a catalyst layer of the present invention, it is possible to produce a catalyst layer with high gas diffusive property inexpensively and easily.

### BRIEF DESCRIPTION OF DRAWINGS

FIG. 1 is a cross-sectional view illustrating an embodiment of the membrane/electrode assembly for a polymer electrolyte fuel cell of the present invention.

FIG. 2 is a cross-sectional view illustrating another embodiment of the membrane/electrode assembly for a polymer electrolyte fuel cell of the present invention.

FIG. 3 is a schematic diagram illustrating an embodiment of a nonwoven structure production apparatus by an electrical field fiber spinning method.

FIG. 4 is a schematic diagram illustrating another embodiment of a nonwoven structure production apparatus by an electrical field fiber spinning method.

FIG. 5 is a cross-sectional view illustrating an embodiment of a fiber spinning nozzle.

FIG. 6 is a cross-sectional view illustrating another embodiment of a fiber spinning nozzle.

FIG. 7 is a graph illustrating a fiber diameter distribution of the fiber constituting the nonwoven structure of Example 4.

FIG. 8 is a graph illustrating a fiber diameter distribution of the fiber constituting the nonwoven structure of Example 5.

### MEANINGS OF SYMBOLS

10: Membrane/electrode assembly
11: Catalyst layer
13: Anode
14: Cathode
15: Polymer electrolyte membrane
40: Fiber spinning nozzle
43: Nozzle
44: Inner liquid flow path
45: Outer liquid flow path
50: Fiber spinning nozzle
53: Outer nozzle
54: Inner nozzle
60: Inner liquid flow path
61: Outer liquid flow path

### DETAILED DESCRIPTION OF THE PREFERRED EMBODIMENTS

In the present specification, a compound represented by the formula (2) is referred to as a compound (2). The same applies to compounds represented by other formulae.

### Membrane/Electrode Assembly

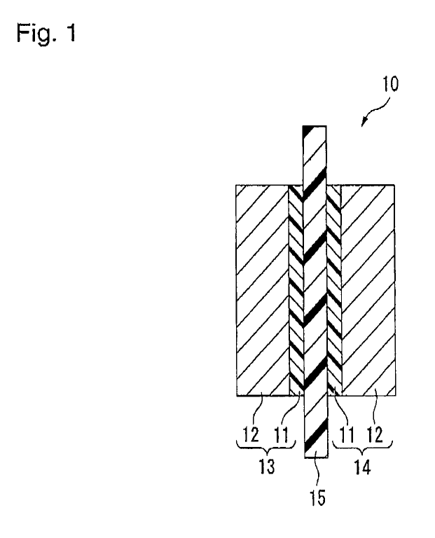

FIG. 1 is a cross-sectional view showing an embodiment of the membrane/electrode assembly for a polymer electrolyte fuel cell of the present invention (hereinafter referred to as a membrane/electrode assembly). A membrane/electrode assembly 10 comprises an anode 13 having a catalyst layer 11 and a gas diffusion layer 12, a cathode 14 having a catalyst layer 11 and a gas diffusion layer 12, and a polymer electrolyte membrane 15 disposed between the anode 13 and the cathode 14 in a state contacted with each catalyst layer 11.

At least one of two catalyst layers 11 is the catalyst layer of the present invention, which will be described later, and preferably each of two catalyst layers 11 is the catalyst layer of the present invention, which will be described later. When one of them is a catalyst layer other than that of the present invention, such another catalyst layer may be a conventional one. For example, such another catalyst layer may be a catalyst layer formed from a dispersion containing an ion-exchangeable fluoropolymer and a catalyst by a coating method, etc. However, in order to sufficiently exhibit the characteristics of the present invention, each of two catalyst layers 11 is preferably the catalyst layer of the present invention, which will be described later. The following description describes a case where each of two catalyst layers 11 is the catalyst layer of the present invention.

### Catalyst Layer

The catalyst layer 11 may be the following catalyst layer:

(A) a catalyst layer having a nonwoven structure of fiber containing an ion-exchangeable fluoropolymer and a catalyst (hereinafter referred to as a catalyst layer (A));

(B) a catalyst layer having a nonwoven structure of fiber containing an ion-exchangeable fluoropolymer, and a catalyst adhered on the nonwoven structure (hereinafter referred to as a catalyst layer (B)); or

(C) a catalyst layer having a nonwoven structure comprising fiber containing an ion-exchangeable fluoropolymer and a catalyst and fiber containing an ion-exchangeable polymer and no catalyst (hereinafter referred to as a catalyst layer (C)).

The ion-exchangeable fluoropolymer may be a perfluorocarbon polymer having a sulfonic group (hereinafter referred to as a sulfonic type perfluorocarbon polymer).

The sulfonic type perfluorocarbon polymer is preferably a copolymer (H) having repeating units based on at least one member selected from the group consisting of a perfluoroolefin (such as tetrafluoroethylene (hereinafter referred to as TFE) or hexafluoropropylene), chlorotrifluoroethylene and perfluoro(alkyl vinyl ether), and repeating units having a sulfonic group, particularly preferably a copolymer (H1) having repeating units based on TFE and repeating units represented by the following formula (1):

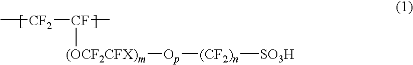

wherein X is a fluorine atom or a trifluoromethyl group,

m is an integer of from 0 to 3, n is an integer of from 1 to 12, and p is 0 or 1.

The copolymer (H) is obtained in such a manner that a compound having a —SO₂F group and TFE are copolymerized to obtain a precursor polymer (F), and then the —SO₂F group in the precursor polymer (F) is converted to a sulfonic group. The conversion of the —SO₂F group to a sulfonic group is carried out by hydrolysis or an acid-forming treatment.

The compound having a —SO₂P group is preferably the compound (2):

CF₂═CF—(OCF₂CFX)ₘ—Oₚ—(CF₂)ₙ—SO₂F (2)

wherein X is a fluorine atom or a trifluoromethyl group, m is an integer of from 0 to 3, n is an integer of from 1 to 12, and p is 0 or 1.

The compound (2) is preferably compounds (21) to (24):

CF₂═CFO(CF₂)_{q}SO₂F (21);

CF₂═CFOCF₂CF(CF₃)O(CF₂)ᵣSO₂R (22);

CF₂═CF(CF₂)₂SO₂F (23); and

CF₂═CF(OCF₂CF(CF₃))ₜO(CF₂)₂SO₂F (24)

wherein q is an integer of from 1 to 8, r is an integer of from 1 to 8, s is an integer of from 1 to 8, and t is an integer of from 1 to 5.

The ion-exchange capacity of the ion-exchangeable fluoropolymer is preferably from 1.1 to 1.8 meq/g dry resin, more preferably from 1.25 to 1.65 meq/g dry resin, from the viewpoint of conductivity and gas diffusion performance.

The catalyst is preferably a catalyst having platinum or a platinum alloy supported on a carbon carrier.

The carbon carrier may be a carbon black powder and is preferably a carbon black powder formed into a graphite by a heat treatment, etc., from the viewpoint of durability.

The specific surface area of the carbon carrier is preferably from 50 to 1,500 m²/g. When the specific surface area of the carbon carrier is in this range, platinum or a platinum alloy is supported on the carbon carrier with good dispersibility, and the activity of an electrode reaction is stabilized for a long period of time.

The platinum or the platinum alloy is highly active for a hydrogen oxidation reaction in the anode 13 and for an oxygen reduction reaction in the cathode 14. Further, by using a platinum alloy, the stability or activity as the catalyst may sometimes further be imparted.

The platinum alloy is preferably an alloy of platinum with at least one metal selected from the group consisting of a platinum group metal other than platinum (ruthenium, rhodium, palladium, osmium or iridium), gold, silver, chromium, iron, titanium, manganese, cobalt, nickel, molybdenum, tungsten, aluminum, silicon, zinc and tin. The platinum alloy may contain an intermetallic compound of platinum and a metal to be alloyed with platinum.

The catalyst of the cathode 14 is preferably a catalyst having a platinum/cobalt alloy supported on the carbon carrier from the viewpoint of durability.

The fiber diameter of fiber constituting a nonwoven structure is preferably 0.1 to 30 μm, preferably from 0.1 to 10 μm. When the fiber diameter is at least 0.1 μm, it is possible to stably spin the fiber without causing breakage in the electrical field fiber spinning method. When the fiber diameter is at most 30 μm, the gas diffusive property of the catalyst layer 11 made of the nonwoven structure becomes sufficiently high.

The fiber diameter of the fiber is obtained in such a manner that the nonwoven structure is observed by an electron microscope, and the widths of at least 100 randomly selected fibers are measured and are averaged out. Or, the cross-section of the nonwoven structure is observed by an electron microscope, and the diameters of at least 100 fibers are measured and are averaged out.

The aspect ratio of the fiber constituting the nonwoven structure is preferably at least 1,000. When the aspect ratio is at least 1,000, the fiber can be regarded to be substantially a continuous fiber, and in the nonwoven structure, a contacting portion of the fiber itself can sufficiently be present. Thus, the shape retention of the catalyst layer 11 made of the nonwoven structure becomes good, and the bulk density decreases, whereby the gas diffusive property of the catalyst layer 11 becomes sufficiently high.

The aspect ratio of the fiber is obtained by observing the fiber constituting the nonwoven structure by e.g. an electron microscope or an optical microscope and measuring the fiber diameter and length of the fiber.

The bulk density of the catalyst layer 11 is from 0.1 to 1.1 g/cc. When the bulk density of the catalyst layer 11 is in this range, the gas diffusive property becomes sufficiently high, and the catalyst layer 11 becomes excellent in shape retention. Therefore, the polymer electrolyte fuel cell provided with the catalyst layer 11 has a high output voltage even when it is operated at a high current density.

The bulk density of the catalyst layer 11 is calculated by the mass per unit area of the catalyst layer 11 and the thickness of the catalyst layer 11. The mass per unit area of the catalyst layer 11 is obtained by the area and the increased mass of a nonwoven structure when the nonwoven structure constituting the catalyst layer 11 is formed on a substrate (such as a gas diffusion layer 12 or a polymer electrolyte membrane 15) having a known mass. The thickness of the catalyst layer 11 is measured by observing the cross section by e.g. an electron microscope.

In the catalyst layer (B), a catalyst may be deposited on at least a part of the surface of the fiber. However, such a catalyst is required to have conductivity over the entire catalyst layer to facilitate an electrode reaction. Therefore, particles of the catalyst are preferably present in contact with one another i.e. not present separately in the form of islands, and further they preferably cover the entire fiber. The catalyst may be supported by a method wherein a dispersion containing the catalyst is sprayed on a nonwoven structure or on fiber immediately after it is formed, or a method wherein a nonwoven structure is impregnated into a dispersion containing the catalyst.

In the catalyst layer (C), it is preferred that fibers having different compositions are uniformly present, and they are sufficiently intertwined with one another.

Further, the fiber constituting the nonwoven structure may contain a polymer other than an ion-exchangeable fluoropolymer, within a range not to impair the effects of the present invention.

Further, the nonwoven structure constituting the catalyst layer 11 may contain fiber which does not contain the ion-exchangeable fluoropolymer, within a range not to impair the effects of the present invention.

Furthermore, the catalyst layer 11 may contain a component other than the nonwoven structure or the catalyst, within a range not to impair the effects of the present invention,

### Gas Diffusion Layer

The constituting material of a gas diffusion layer 12 may be a porous carbon sheet such as a carbon paper, a carbon cloth or a carbon felt. The gas diffusion layer 12 is preferably treated for water repellency with e.g. polytetrafluoroethylene (hereinafter referred to as PTFE). The gas diffusion layer 12 is formed by laminating a sheet for the gas diffusion layer such as the above carbon paper on the catalyst layer. Further, by forming spun fiber on such a sheet, it is possible to form a catalyst-containing nonwoven structure laminated on the sheet.

### Polymer Electrolyte Membrane

A polymer electrolyte membrane 15 is a membrane containing an ion-exchange polymer.

The ion-exchange polymer may be an ion-exchangeable fluoropolymer or an ion-exchangeable non-fluoropolymer, From the viewpoint of durability, the ion-exchangeable fluoropolymer is preferred, and the above-mentioned copolymer (H1) is more preferred. Further, by forming spun fiber on the polymer electrolyte membrane, it is possible to form a catalyst-containing nonwoven structure laminated on the polymer electrolyte membrane.

The ion-exchangeable non-fluoropolymer may be a is polymer which has a sulfonic group but does not contain a fluorine atom. Such a polymer may, for example, be a polymer having an aromatic ring and having a structure wherein a sulfonic group is introduced in the aromatic ring, and its ion-exchange capacity is from 0.8 to 3.0 meq/g dry resin. Specifically, it may, for example, be sulfonated polyarylene, sulfonated polybenzoxazole, sulfonated polybenzothiazole, sulfonated polybenzimidazole, sulfonated polysulfone, sulfonated polyether sulfone, sulfonated polyether ether sulfone, sulfonated polyphenylene sulfone, sulfonated polyphenylene oxide, sulfonated polyphenylene sulfoxide, sulfonated polyphenylene sulfide, sulfonated polyphenylene sulfide sulfone, sulfonated polyether ketone, sulfonated polyether ether ketone, sulfonated polyether ketone ketone or sulfonated polyimide.

The polymer electrolyte membrane 15 may contain a reinforcing material. The reinforcing material may, for example, be a porous material, fiber, a woven cloth or a nonwoven structure. The material for the reinforcing material may, for example, be PTFE, a tetrafluoroethylene/hexafluoropropylene copolymer, a tetrafluoroethylene/perfluoro(alkyl vinyl ether) copolymer, polyethylene, polypropylene or polyphenylene sulfide.

### Carbon Layer

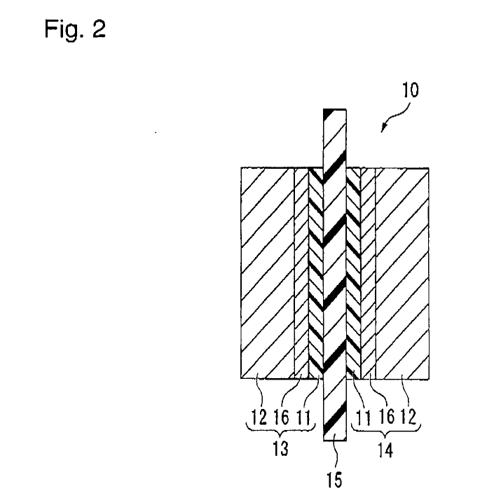

A membrane/electrode assembly 10 may have a carbon layer 16 between the catalyst layer 11 and the gas diffusion layer 12, as shown in FIG. 2. By locating the carbon layer 16, gas diffusion performance on the surface of the catalyst layer 11 improves, and the power generating characteristic of a polymer electrolyte fuel cell greatly improves.

The carbon layer 16 is a layer containing carbon and a nonionic fluoropolymer.

The carbon is preferably a carbon nanofiber having a fiber diameter of from 1 to 1,000 nm and a fiber length of at most 1,000 μm. The non-ionic fluoropolymer may be PTFE, etc.

With respect to the above-described electrode (anode 13 or cathode 14) for a polymer electrolyte fuel cell, the catalyst layer 11 has a nonwoven structure containing fiber of an ion-exchangeable fluoropolymer, the fiber diameter of the fiber is from 0.1 to 30 μm, and the bulk density of the catalyst layer 11 is from 0.1 to 1.1 g/cc, whereby the gas diffusive property is high. Therefore, a polymer electrolyte fuel cell provided with such an electrode exhibits good characteristics even when it is operated at a high current density.

Further, the above-described membrane/electrode assembly 10 has the catalyst layer 11 with high gas diffusive property. Therefore, a polymer electrolyte fuel cell provided with the membrane/electrode assembly 10 exhibits good characteristics even when it is operated at a high current density. Further, as mentioned above, one of the catalyst layers of the anode 13 and cathode 14, may be a catalyst layer constituted by another material, and even in such a case, the characteristics by the catalyst layer in the present invention can sufficiently be exhibited.

### Process for Producing Membrane/Electrode Assembly

The membrane/electrode assembly 10 may, for example, be produced by the following process:

(I) A process wherein a catalyst layer 11 is formed on each side of a polymer electrolyte membrane 15 to obtain a membrane/catalyst layer assembly, and such a membrane/catalyst layer assembly is sandwiched by gas diffusion layers 12; or

(II) a process wherein a catalyst layer 11 is formed on a sheet for the gas diffusion layer 12 to obtain an electrode (anode 13, cathode 14), and a polymer electrolyte membrane 15 is sandwiched by such electrodes.

Further, when the membrane/electrode assembly 10 has a carbon layer 16, the membrane/electrode assembly 10 is, for example, produced by the following process:

(III) A process wherein a dispersion containing carbon and a nonionic fluoropolymer is applied on each gas diffusion layer 12, followed by drying to form a carbon layer 16, and the membrane/catalyst layer assembly in the above process (I) is sandwiched by such gas diffusion layers 12 having the carbon layer 16.

The polymer electrolyte membrane 15 and the gas diffusion layer 12 which are used in processes (I) to (III), may be in the form of a sheet or a web (a continuous web).

When the catalyst layer 11 is made of a catalyst-containing nonwoven structure of the present invention, it is possible to form the catalyst layer 11 in such a manner that the catalyst-containing nonwoven structure already formed on a substrate is laminated on e.g. the above polymer electrolyte membrane or sheet for the gas diffusion layer, followed by removing the substrate. Also when the catalyst layer 11 is one obtained by subjecting the catalyst-containing nonwoven structure of the present invention to further processing (e.g. processing to impregnate other materials or processing for surface treatment with other materials), such processing is carried out on a substrate, and then, the processed catalyst-containing nonwoven structure is laminated on the polymer electrolyte membrane or a sheet for the gas diffusion layer, followed by removing the substrate. On the other hand, when the polymer electrolyte membrane or the sheet for the gas diffusion layer is used as a substrate, removing the substrate will be unnecessary. Therefore, the catalyst-containing nonwoven structure is preferably formed by forming fiber on the surface of a sheet material constituting the membrane/electrode assembly 10, such as a polymer is electrolyte membrane or a sheet for the gas diffusion layer.

### Electrical Field Fiber Spinning Method

The catalyst-containing nonwoven structure for the catalyst layer 11 is produced by spinning a stock solution for spinning containing the ion-exchangeable fluoropolymer to form fiber and gathering such fiber on a substrate. With respect to the above processes (I) to (III), fiber is formed from a stock solution for spinning containing the ion-exchangeable fluoropolymer, and such fiber is formed on a polymer electrolyte membrane (in the case of (I)), on a sheet for a gas diffusion layer (in the case of (II)) or on a sheet for a gas diffusion layer having a carbon layer formed thereon (in the case of (III)), to obtain a nonwoven structure. Hereinafter, a process for forming a nonwoven structure by an electrical field fiber spinning method will be described with reference to a case where a nonwoven structure is formed on a surface of such a sheet material constituting a membrane/electrode assembly.

The electrical field fiber spinning method is a method of spinning to form fiber electrically by applying a high voltage to the stock solution for spinning.

The electrical field fiber spinning method has the following features.

(i) Fiber can be produced by a simple apparatus as compared with other methods.

As such other methods of producing a nonwoven structure, a melt-blown method, a spun bond method, a paper making method, etc. are known. However, each method requires costs on apparatus such that a large-scale nonwoven structure production apparatus is needed, and a separate fiber production apparatus is needed to prepare a fiber raw material.

(ii) Fine fiber can be obtained.

To produce a nonwoven structure constituted by fine fiber by using an usual fiber spinning facility is difficult from the viewpoint of conditions, and there are many restrictions on e.g. the viscosity, stretchability, etc. of a raw material. On the other hand, the electrical field fiber spinning method is a spinning method using a solution, whereby since a volume shrinkage takes place in its drying step, and the viscosity of the raw material itself is low, it is possible to carry out spinning with an ultrathin nozzle, and the fine fiber is easily obtainable.

(iii) A pile of fiber is obtained usually as a nonwoven structure having fiber bonded to itself.

In the electrical field fiber spinning method, solidification from the solution and spinning by stretching take place simultaneously or sequentially, whereby the pile of fiber is obtained as a nonwoven structure having the fiber bonded to itself.

### Stock Solution for Spinning

As the stock solution for spinning, the following one is used depending on the shape of the desired catalyst layer 11.

For the production of the catalyst-containing nonwoven structure for a catalyst layer (A), a stock solution for spinning (a) containing an ion-exchangeable fluoropolymer and a catalyst, is used.

For the production of the catalyst-containing nonwoven structure for a catalyst layer (B), a stock solution for spinning (b) containing an ion-exchangeable fluoropolymer and no catalyst, is used.

For the production of the catalyst-containing nonwoven structure for a catalyst layer (C), the stock solution for spinning (a) and the stock solution for spinning (b) are used.

### Stock Solution for Spinning (a):

The stock solution for spinning (a) is a dispersion wherein an ion-exchangeable fluoropolymer and a catalyst are dispersed in a dispersion medium.

The dispersion medium is preferably a solvent mixture of an organic solvent having a hydroxyl group with water.

The organic solvent having a hydroxyl group is preferably an organic solvent having a main chain with from 1 to 4 carbon atoms, for example, methanol, ethanol, n-propanol, isopropanol, tert-butanol or n-butanol. The organic solvent having a hydroxyl group may be used alone, or two or more of such solvents may be used in combination as a mixture.

The proportion of water is preferably at least 10 mass %, more preferably at least 20 mass % in the solvent mixture (100 mass %). The proportion of water may be 100 mass %, but it is preferably at most 99 mass %, more preferably at most 80 mass %. When the proportion of water is at least 10 mass %, it is easy to form fiber. When the proportion of water is at most 99 mass %, it is easy to adjust the viscosity of the stock solution for spinning. With respect to the solvent mixture of water with ethanol, the proportion of water is preferably from 15 to 100 mass % in the solvent mixture (100 mass %). The total proportion of the ion-exchangeable fluoropolymer and the catalyst is preferably from 1 to 30 mass %, more preferably from 5 to 15 mass % in the stock solution for spinning (a) (100 mass %), to obtain a proper viscosity level.

Further, the mass ratio of the ion-exchangeable fluoropolymer to the catalyst (the polymer/the catalyst) in the stock solution for spinning (a) is preferably from 0.2 to 4.0. If the mass ratio is in such a range, the conductivity and gas diffusion performance of the catalyst layer 11 become good.

The stock solution for spinning (a) preferably contains polyalkylene oxide (hereinafter referred to as PAO) or polyvinyl alcohol (hereinafter referred to as PVA) from the viewpoint that fiber can be stably formed. As PAO, polyethylene oxide (hereinafter referred to as PEO) is preferred.

The molecular weight of PEO is preferably at lest 100,000, more preferably at least 200,000. Further, the molecular weight of PEO is at most 10,000,000, more preferably at most 8,000,000, further preferably at most 5,000,000. When the molecular weight of PER is in such a range, fiber can be stably formed. The molecular weight of PEO is a viscosity average molecular weight determined from a viscosity value of from 1% to 5% of an aqueous solution by using Brookfield viscometer.

The proportion of PAO or PVA is preferably at least 0.05 masse, more preferably at least 0.5 mass %, in the stock solution for spinning (a) (100 mass %). Further, its upper limit is preferably 20 mass %, more preferably 10 mass %. When the proportion of PAO or PVA is in such a range, fiber can be stably formed.

The viscosity of the stock solution for spinning (a) is preferably at least 100 mPa·s, more preferably at least 200 mPa·s. Further, the viscosity is preferably at most 5,000 mPa·s, more preferably at most 2,500 mPa·s. When the viscosity of the stock solution for spinning (a) is in such a range, fiber can be easily formed.

The viscosity of the stock solution for spinning is measured by using TV-29 Model Viscometer (manufactured by Toki Sangyo Co., Ltd.) equipped with cone plate type is (rotor code: 01, rotor No.: 1° 34′XR24) at 25° C.

### Stock Solution for Spinning (b):

The stock solution for spinning (b) is a dispersion wherein an ion-exchangeable fluoropolymer is dispersed in a dispersion medium.

The dispersion medium is preferably a solvent mixture of an organic solvent having a hydroxyl group with water.

The organic solvent having a hydroxyl group may be the above-mentioned organic solvent.

The proportion of water is preferably at least 10 mass %, more preferably at least 20 mass %, in the solvent mixture (100 mass %). Further, the proportion of water is preferably at most 99 mass %, more preferably at most 80 mass %. When the proportion of water is at least 10 mass %, fiber can easily be formed. When the proportion of water is at most 99 mass %, it is easy to adjust the viscosity of the stock solution for spinning.

The proportion of the ion-exchangeable fluoropolymer is preferably at least 20 mass %, more preferably at least 25 mass % in the stock solution for spinning (b) (100 mass %). Further, the proportion of the ion-exchangeable fluoropolymer is preferably at most 40 mass %, more preferably at most 35 mass %. When the proportion of the ion-exchangeable fluoropolymer is in such a range, fiber can easily be formed.

The stock solution for spinning (b) preferably is contains PAO of PVA from the viewpoint that fiber can stably be formed. As PAO, PEO is preferred.

The molecular weight of PEO is preferably the same as in the stock solution for spinning (a).

The proportion of PAO or PVA is preferably at least 0.01 mass %, more preferably at least 1 mass %, in the stock solution for spinning (b) (100 mass %). Further, its upper limit is preferably 20 mass %, more preferably 10 mass %. When the proportion of PAO or PVA is in such a range, fiber can stably be formed.

The viscosity of the stock solution for spinning (b) is preferably at least 100 mPa·s, more preferably at least 200 mPa·s. Further, the viscosity is preferably at most 5,000 mPa·s, more preferably at most 2,500 mPa·s. When the viscosity of the stock solution for spinning (b) is in such a range, fiber can easily formed.

### Formation of Catalyst-Containing Nonwoven Structure Production of Catalyst-Containing Nonwoven Structure for Catalyst Layer (A):

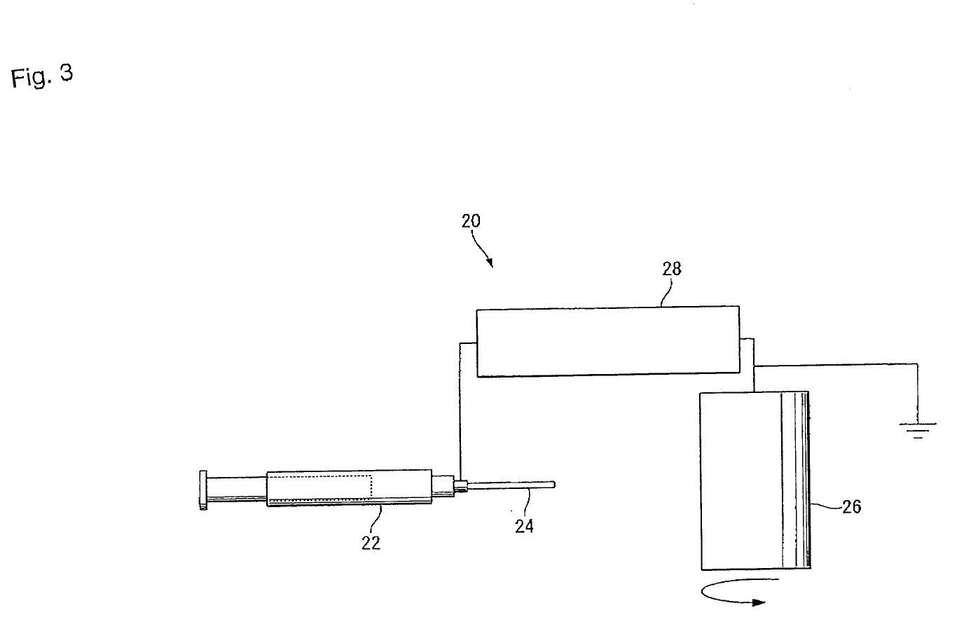

For the production of a catalyst-containing nonwoven structure for the catalyst layer (A), for example, a nonwoven structure production apparatus 20 as shown in FIG. 3 is used in the electrical field fiber spinning method. The nonwoven structure production apparatus 20 comprises a syringe 22 to be filled with a stock solution for spinning, a rotatable collector drum 26 set to face a nozzle 24 attached to the front tip of the syringe 22, a high voltage power source 28 to apply a high voltage between the nozzle 24 and the collector drum 26, and a syringe pump (not shown) to discharge the stock solution for spinning at a constant flow amount by moving the plunger portion of the syringe 22 to a discharging direction at a constant rate.

As the nozzle 24, a needle or the like is used.

First, the stock solution for spinning (a) is filled in the syringe 22. Further, a substrate (a polymer electrolyte membrane or a sheet for a gas diffusion layer) is placed on the collector drum 26.

While rotating the collector drum 26, by the high voltage power source 28, a high voltage is applied between the nozzle 24 and the collector drum 26. By having the syringe pump operated, the stock solution for spinning (a) is discharged from the nozzle 24 at a constant rate. When the voltage is applied to the front tip of the nozzle 24, if an electrostatic attracting force exceeds the surface tension of the stock solution for spinning (a), the stock solution for spinning (a) transforms into a circular cone called as Taylor cone at the front tip of the nozzle 24, and the front tip of the cone is stretched. The stretched stock solution for spinning (a) will be micro-sized by an electrostatic repulsion of a positively charged stock solution for spinning. The solvent instantaneously evaporates from the micro-sized stock solution for spinning (a), whereby is fine fiber is formed. The positively charged fiber is adhered on the substrate set on a negatively charged collector drum 26. As the fiber is formed on the substrate set on the rotatable collector drum 26, a nonwoven structure is obtained.

The discharging amount of the stock solution for spinning (a) is preferably at least 0.5 mL/hr, more preferably at least 1 mL/hr. Further, the discharging amount of the stock solution for spinning (a) is preferably at most 20 mL/hr, more preferably 10 mL/hr. When the discharging amount of the stock solution for spinning (a) is at least 0.5 mL/hr, the nozzle 24 is not easily clogged, or fiber is not easily broken. When the discharging amount of the stock solution for spinning (a) is at most 20 mL/hr, thin fiber can be formed.

The inner diameter of the front tip of the nozzle 24 is preferably at least 0.05 mm, more preferably at least 0.1 mm. Further, the inner diameter is preferably at most 2 mm, more preferably at most 1 mm. When the inner diameter of the front tip of the nozzle 24 is at least 0.05 mm, the nozzle 24 is not easily clogged. When the inner diameter of the front tip of the nozzle 24 is at most 2 mm, thin fiber can be formed.

The distance from the front tip of the nozzle 24 to the collector drum 26 is preferably at least 3 cm, more preferably at least 5 cm. Further, the distance is at most 30 cm, more preferably at most 20 cm. When the distance is at least 3 cm, electrical discharge can be suppressed. When the distance is at most 30 cm, fiber can easily be formed.

The voltage to be applied between the nozzle 24 and the collector drum 26 is preferably at least 3 kV, more preferably at least 10 kV. The applied voltage is preferably at most 50 kV, more preferably at most 30 kV. When the voltage is at least 3 kV, fiber can easily be formed. When the voltage is at most 50 kV, electrical discharge can be suppressed.

### Production of Catalyst-Containing Nonwoven Structure for Catalyst Layer (B):

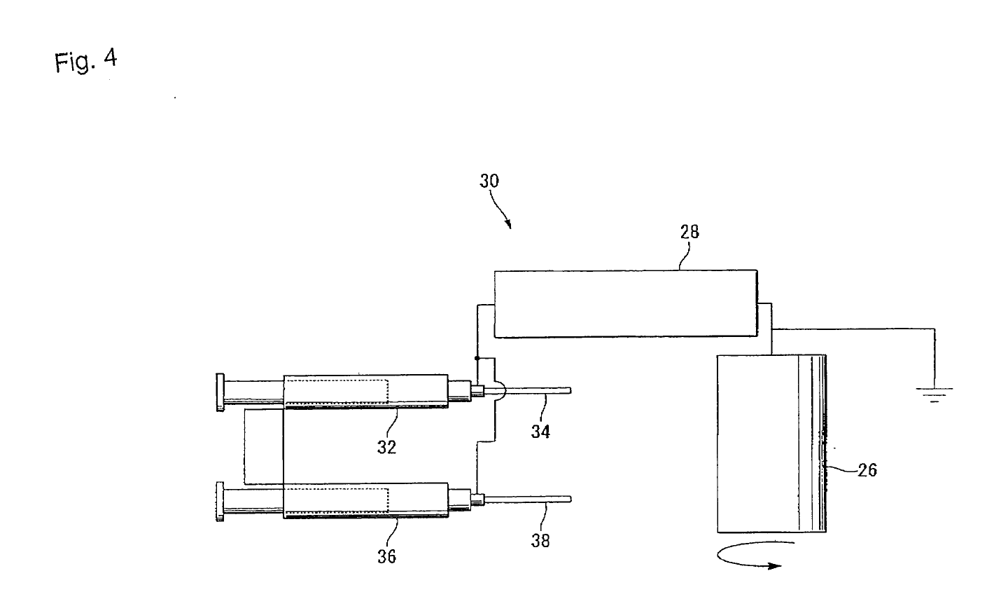

For the production of a catalyst-containing nonwoven structure of the catalyst layer (B), for example, a nonwoven structure production apparatus 30 as shown in FIG. 4 is used by the electrical field fiber spinning method. The nonwoven structure production apparatus 30 comprises a first syringe 32 having a nozzle 34 attached at the front tip and a second syringe 36 having a nozzle 38 attached at the front tip, instead of the syringe 22 in the nonwoven structure production apparatus 20.

First, the stock solution for spinning (b) is filled in the first syringe 32, and a catalyst liquid (c) containing a catalyst is filled in the second syringe 36. Further, on the collector drum 26, a substrate (a polymer electrolyte membrane or a sheet for a gas diffusion layer) is located.

While rotating the collector drum 26, by the high voltage power source 28, a high voltage is applied between the nozzles 34 and 38 and the collector drum 26.

By having a syringe pump (not shown) of the first syringe 32 operated, the stock solution for spinning (b) is discharged from the nozzle 34 at a constant rate to form fine fiber. The positively charged fiber is adhered on a substrate located on a negatively charged collector drum 26. By forming the fiber on the substrate located on the rotating collector drum 26, a nonwoven structure is obtained.

Simultaneously, having the syringe pump (not shown) of the second syringe 36 operated to discharge the catalyst liquid (c) at a constant rate from the nozzle 38 and to spray the catalyst liquid (c) on fiber immediately after formed between the nozzle 34 and the collector drum 26 and fiber (nonwoven structure) formed on the substrate, whereby a nonwoven structure containing a catalyst is formed. The catalyst can be applied not only by spraying but also by, for example, a method of impregnating the nonwoven structure into the catalyst liquid (c).

The discharging amount of the stock solution for spinning (b) is preferably in the same range as the discharging amount of the above stock solution for spinning (a).

The discharging amount of the catalyst liquid (c) is preferably at least 0.1 mL/hr, more preferably at least 1 mL/hr. Further, the discharging amount of the catalyst liquid (c) is preferably at most 100 mL/hr, more preferably 20 mL/hr.

The inner diameter of the front tip of each of the nozzle 34 and the nozzle 38 is preferably in the same range as the inner diameter of the front tip of the above-described nozzle 24.

The distance from each front tip of the nozzle 34 and the nozzle 38 to the collector drum 26 is preferably in the range of the distance from the above nozzle 24 to collector drum 26.

The voltage to be applied between the nozzles 34 and 38 and the collector drum 26 is preferably in the same range as the voltage to be applied between the above-described nozzle 24 and collector drum 26.

### Production of Catalyst-Containing Nonwoven Structure for Catalyst Layer (C):

For the production of a catalyst-containing nonwoven structure for the catalyst layer (C), for example, a nonwoven structure production apparatus 30 as shown in FIG. 4 is used by the electrical field fiber spinning method.

First, the stock solution for spinning (a) is filled in the first syringe 32, and the stock solution for spinning (b) is filled in the second syringe 36. Further, on the collector drum 26, a substrate (a polymer electrolyte membrane or a sheet for a gas diffusion layer) is located.

While rotating the collector drum 26, by the high voltage current 28, a high voltage is applied between the nozzles 34 and 38 and the collector drum 26.

By having the syringe pump of the first syringe 32 operated, the stock solution for spinning (a) is discharged from the nozzle 34 at a constant rate to form fine fiber. The positively charged fiber is adhered on a substrate located on a negatively charged collector drum 26.

Simultaneously, having the syringe pump of the second syringe 36 operated to discharge the stock solution for spinning (b) from the nozzle 38 at a constant rate and thereby to form fine fiber. The positively charged fiber is adhered on the substrate located on a negatively charge collector drum 26.

As such two types of fibers are formed on the substrate located on the rotating collector drum 26, a nonwoven structure is obtained.

The discharging amount of the stock solution for spinning (a) is preferably in the same range as the discharging amount of the above-described stock solution for spinning (a).

The discharging amount of the stock solution for spinning (b) is preferably in the same range as the discharging amount of the above-described stock solution for spinning (b).

### Fiber Spinning Nozzle

Instead of the above-described syringe, it is possible to use the following fiber spinning nozzle. By using the fiber spinning nozzle, it is possible to spin fiber having its composition continuously or gradually changed from the center in the cross section of the fiber to a circumferential surface of the fiber.

(x) A fiber spinning nozzle (hereinafter referred to as a fiber spinning nozzle (x)) which has n flow paths, and one nozzle which discharges n types of fiber spinning solutions merged at the outlet end of the flow paths in a state of multiple layers. n is preferably from 2 to 4.

(y) A fiber spinning nozzle (hereinafter referred to as fiber spinning nozzle (y)) having multiple nozzles wherein n number of nozzles having different diameters are located concentrically to form a flow path between the adjacent nozzles. n is preferably from 2 to 4.

### Fiber Spinning Nozzle (x):

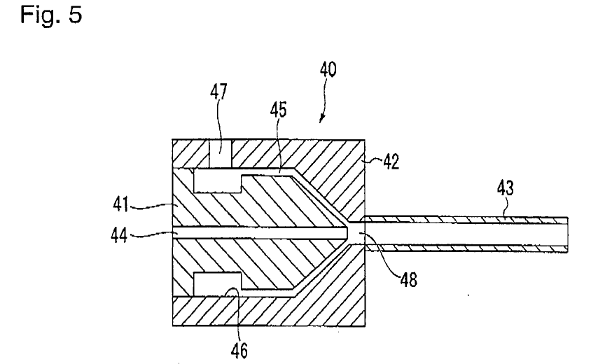

FIG. 5 is a cross-sectional view illustrating an embodiment of the fiber spinning nozzle (x). The fiber spinning nozzle 40 comprises an inner block 41, an outer block 42 containing the inner block 41, and a nozzle 43.

The inner block 41 is a substantially cylindrical body wherein the diameter of one end surface gradually decreases to form a circular cone. In the inner block 41, an inner liquid flow path 44 is formed to pass through from the other end surface to the apex of the circular cone in an axial direction.

The outer block 42 is a bottomed cylindrical body having a size and a shape of a concave portion 46 to form a space for an outer liquid flow path 45 between the outer block 42 and the inner block 41. The outer block 42 comprises an outer liquid feed opening 47 to supply an outer liquid to the outer liquid flow path from the circumferential side, and a discharging opening 48 which passes through the middle of the bottom.

The nozzle 43 is a tubular body wherein its base portion is connected to the discharging opening 48 of the outer block 42.

With respect to the fiber spinning nozzle 40, the inner liquid (stock solution for spinning) which is supplied from a base portion of the inner liquid flow path 44 and is discharged from an end portion of the inner liquid flow path 44, and the outer liquid (stock solution for spinning) having a different composition from the inner liquid, which is supplied from the outer liquid feed opening 47 and flows through the outer liquid flow path towards the discharging opening 48 of an end portion, merge at the discharging opening 48 to form a two-layered flow as the outer liquid surrounds the circumference of the inner liquid. While such a two-layered flow is kept as it is, the inner liquid and outer liquid flow through the nozzle 43 and a discharged from the front portion of the nozzle 43. At that time, by applying a high voltage between the nozzle 43 and the collector drum (not shown), fiber having different compositions at the middle of the cross section and at the circumferential area, namely a core-in-sheath fiber is formed.

In each of the flow paths in the fiber spinning nozzle 40, the inner liquid and the outer liquid are preferably in a state of laminar flow.

### Fiber Spinning Nozzle (y):

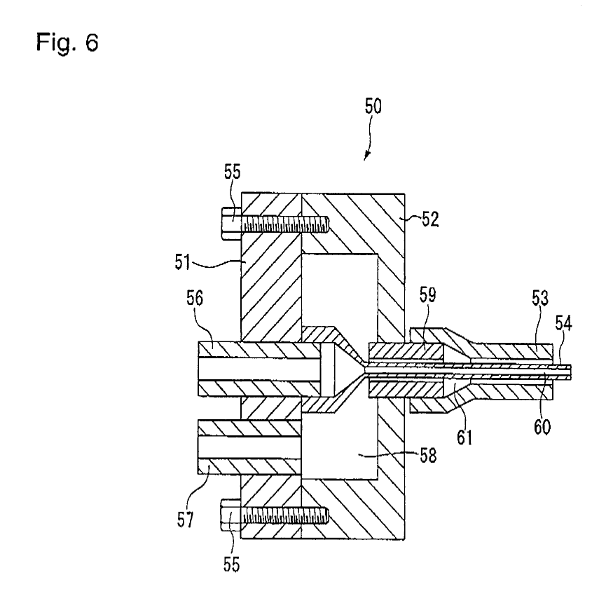

FIG. 6 is a cross-sectional view illustrating an embodiment of the fiber spinning nozzle (y). A fiber spinning nozzle 50 comprises a first block 51, a second block 52 adjacent to the first block 51, an outer nozzle 53, an inner nozzle 54 and a bolt 55 to fix the first block 51 to the second block 52.

The first block 51 is a circular disk block. The first block 51 is provided with an inner liquid feed tube 56 and an outer liquid feed tube 57, which pass through the first block 51.

The second block 52 is a bottomed cylindrical body which is communicated with the outer liquid feed tube 57 and has a concave portion for the outer liquid storage portion 58. The second block 52 is provided with a discharging tube 59 which passes through the bottom portion of the second block 52.

The outer nozzle 53 is a tubular body, and its base portion is connected to the discharging tube 59 of the second block 52.

The inner nozzle 54 is a tubular body having a smaller diameter than the outer nozzle 53, its base portion is connected to the inner liquid feed tube 56 of the first block 51, it is inserted in the discharge tube 59 of the second block 52 and inside of the outer nozzle 53, and its front portion is protruded from the front portion of the outer nozzle 53.

The outer nozzle 53 and the inner nozzle 54 are located concentrically to form a flow path between the adjacent nozzles, and they constitute a double nozzle.

In the fiber spinning nozzle 50, inside of the inner nozzle 54 becomes a inner liquid flow path 60. Further, the space between the inner nozzle 54 and the discharge tube 59 and the space between the inner nozzle 54 and the outer nozzle 53 become an outer liquid flow path el.

In the fiber spinning nozzle 50, at the same time as the inner liquid supplied from the inner liquid feed tube 56 flows through the inner liquid flow path 60 and is discharged from the front portion of the inner nozzle 54, the outer liquid supplied from the outer liquid feed tube 57 flows through the outer liquid flow path 61 via the outer liquid storage portion 58 and is discharged from the front portion of the outer nozzle 53. At that time, by applying a high voltage between the outer nozzle 53 and the collector drum (not shown), fiber having different compositions at the center in the cross section and at the circumferential surface, namely, a core-in-sheath fiber is formed.

The core-in-sheath fiber to be formed by using the fiber spinning nozzle may, for example, be the following fiber.

(α) Core-in-sheath fiber (hereinafter referred to as core-in-sheath fiber (α)) formed by using the stock solution for spinning (b) as the inner liquid and the stock solution for spinning (a) as the outer liquid.

(β) Core-in-sheath fiber (hereinafter referred to as core-in-sheath fiber (β)) formed by using the stock solution for spinning (a) as the inner liquid and the stock solution for spinning (b) as the outer liquid.

The core-in-sheath fiber (α) is one wherein a catalyst is locally distributed at the circumferential surface side of the fiber, and the center in the cross section is fiber made mainly of the ion-exchangeable fluoropolymer. The core-in-sheath fiber (α) is excellent in proton conductivity in a length direction and excellent in reactivity with a raw material gas supplied from an outer portion.

The core-in-sheath fiber (β) is one wherein the catalyst is locally distributed at the center in cross section of the fiber, and the circumferential surface side is fiber made mainly of the ion-exchangeable fluoropolymer. The core-in-sheath fiber (β) is excellent in electron conductivity in a length direction, and it becomes easy to supply protons to the reaction Bite (circumferential surface side).

For example, in the catalyst layer 11, by forming an nonwoven structure in such a way that the core-in-sheath fiber (β) is locally distributed to the side of the polymer electrolyte membrane 15, and the core-in-sheath fiber (α) is locally distributed to the side of the gas diffusion layer 12, protons can be made easily supplied from the polymer electrolyte membrane 15, and the reactivity of the catalyst layer 11 can be made high. When such a nonwoven structure is formed, from the viewpoint of improving performance, it is preferred to form material transfer interface as much as possible between fibers by pressurizing and compressing the nonwoven structure.

By forming a catalyst layer 11 by using the nonwoven structure produced by the above-described production process, it is possible to form a catalyst layer 11 with high gas diffusive property. Further, it is not necessary to use a fluorinated alcohol, and the catalyst layer 11 can be produced with a low cost. Further, since it is possible to form a nonwoven structure by a pile of fiber formed from a stock solution for spinning on a polymer electrolyte membrane or a sheet for a gas diffusion layer, the operation of forming the catalyst layer 11 is simplified, and consequently, the production of the membrane/electrode assembly 10 becomes easy.

### Polymer Electrolyte Fuel Cell

The membrane/electrode assembly of the present invention is used for a polymer electrolyte fuel cell. The polymer electrolyte fuel cell is, for example, produced by sandwiching the membrane/electrode assembly with two separators to form a cell, followed by making a stack of several cells.

The separator may be e.g. a conductive carbon board wherein trenches are formed to provide paths for a fuel gas or an oxidizing agent containing oxygen (e.g. air or oxygen).

The types of the polymer electrolyte fuel cell may, for example, be a hydrogen/oxygen type fuel cell and a direct methanol type fuel cell (DMFC).

### EXAMPLES

Now, the present invention will be described in further detail with reference to Examples, but it should be understood that the present invention is by no means restricted thereto.

Examples 1 to 5 are Examples of the present invention, and Example 6 is Comparative Example.

### Viscosity

The viscosity of the solvent was measured by using an E-Model Viscometer (manufactured by TOKI Sangyo Co., Ltd.) with a shear rate of 1⁻¹ second.

### Average Fiber Diameter

In Examples 1 to 3, an electron microscopic photograph of the nonwoven structure was taken, and widths of randomly selected 140 fibers were measured and were averaged out.

In Examples 4 and 5, the nonwoven structure was embedded in an epoxy resin, and it was cross-sectionally cut by using a microtome, followed by observing the cross section by an electron microscope and measuring the diameter of the observed fiber. Measured were 140 fibers.

### Thickness of Electrode Layer

It was measured by using a flat contactor with 5 mm φ of a contacting micrometer for a general purpose ID-F125 manufactured by Mitautoyo Corporation. At the time of measurement, the thickness of a substrate on which an electrode containing a polymer electrolyte, etc. is to be formed, was measured in advance, and after the formation of the electrode, the entire thickness was measured, and the increased amount was taken as the thickness of the electrode layer.

### Length of Fiber

The electron microscopic photograph of the nonwoven structure was continuously taken in a range of 2 mm or 3 mm, and it was confirmed that there was no fiber having both terminal portions observed in such a range.

### Power Generating Performance

The membrane/electrode assembly was inserted in a fuel cell evaluation cell with an area of 25 cm² having a is serpentine type flow path for a general purpose. The both sides were pressurized with a pressure of 0.5 MPa, a hydrogen gas was supplied to the anode at 0.5 L/min, and air was supplied to the cathode so that the oxygen gas became 1.2 L/min, whereby the output voltage at a cell temperature of 80° C. was measured. The gas humidification temperature was set at 80° C.

### Example 1

### Production of Polymer Electrolyte Membrane

On a film (manufactured by Asahi Glass Company, Limited, thickness: 100 μm) of an ethylene/tetrafluoroethylene copolymer (hereinafter referred to as ETFE), an ethanol solution (solid content: 9 mass %) of a copolymer (H11) (Flemion (R), manufactured by Asahi Glass Company, Limited, ion-exchange capacity; 1.1 meq/g dry resin) having repeating units based on TFE and repeating units represented by the following formula (11) was cast and dried in a commercially available circulation dryer at 80° C. for 30 minutes to obtain a polymer electrolyte membrane having a thickness of 10 μm. Further, the same operation was repeated twice to obtain a polymer electrolyte membrane (MA1) with an ETFE film, having a thickness of 30 μm. Further, the membrane was heated in a commercially available circulation dryer at 160° C. for 30 minutes to carry out an anneal treatment.

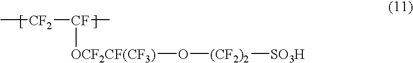

Preparation of Catalyst Liquid (c1):

Into a hermetically-sealable cylindrical polyethylene bottle (internal volume: 100 cc), 5 g of platinum supported carbon (TEC10E50E, manufactured by Tanaka Kikinzoku Kogyo K.K., platinum supporting ratio: 50 mass %) and 25.7 g of distilled water were added, followed by stirring, and 5.4 g of ethanol was further added thereto. Then, 22.2 g of an ethanol solution (solid content: 9 mass %) of the copolymer (H11) was added thereto. Further, ZrO₂ particles having a diameter of 5 mm were added thereto to occupy about 40 cc, and then the polyethylene bottle was rotated on the commercially available ball mill rotating table for 24 hours to obtain a catalyst liquid (c1).

Preparation of PEO Solution (d1):

Into a flask, 9 g of PEO (mass average molecular weight; 1,000,000) and 91 g of water were added refluxed at 80° C. with stirring to dissolve PEO, whereby a PEO aqueous solution was obtained. After cooling the PEO aqueous solution to room temperature, 100 g of ethanol was added thereto, followed by stirring for 24 hours to obtain a PEO solution (d1). The viscosity of the PEO solution (d1) was 23,250 mPa·sec.

Preparation of Stock Solution for Spinning (a1):

Into a hermetically-sealable cylindrical polyethylene bottle (internal volume: 100 cc), 20 g of the catalyst liquid (c1) and 8 g of the PEO solution (d1) were added, and further, after ZrO₂ particles having a diameter of 5 mm were added thereto to occupy about 20 cc, the polyethylene bottle was rotated on the commercially available ball mill rotating table for 2 hours to obtain a stock solution for spinning (a1).

### Formation of Catalyst Layer (A1):

The nonwoven fabric production apparatus 20 as shown in FIG. 3 was prepared. As the nozzle 24, an injection needle having an inner diameter of 0.8 mm and an outer diameter of 1.2 mm, was used. The shortest distance from the front end of the nozzle 24 to the collector drum 26 was set to be 10 cm.

First, the stock solution for spinning (a1) was filled in the syringe 22. Further, the polymer electrolyte membrane (MA1) was wound on the collector drum 26.

While rotating the collector drum 26, by the high voltage power source 28, 10 kV of DC voltage was applied between the nozzle 24 and the collector drum 26. By having the syringe pump operated, the stock solution for spinning (a1) was discharged from the nozzle 24 at 5 mL/hr to form fine fiber. The fiber was formed on the polymer electrolyte membrane (MA1) on the rotating collector drum 26 to form a nonwoven structure, whereby a catalyst layer (A1) was formed, and a membrane/catalyst layer assembly (MC1) was obtained.

The average fiber diameter of the fiber constituting the nonwoven structure was 2 μm. Fiber having a fiber length of at most 2 mm was not observed.

The thickness of the catalyst layer (A1) was 19.5 μm, and the bulk density was 0.58 g/cc. The platinum amount per unit area of the catalyst layer (A1) was 0.4 mg/cm².

### Example 2

### Preparation of Stock Solution for Spinning (b1)

Into a water/ethanol solution (solvent composition: water/ethanol=4/6 mass ratio, solid content: 27 mass %) of the copolymer H(11), PEO (mass average molecular weight: 1,000,000) was added to be 0.1 mass %, and then the mixture was mixed by using a magnetic stirrer at room temperature for 1 hour to obtain a stock solution for spinning (b1).

### Formation of Catalyst Layer (B1):

The nonwoven structure production apparatus 30 as shown in FIG. 4 was prepared. As the nozzle 34 and the nozzle 38, injection needles having an inner diameter of 0.8 mm and an outer diameter of 1.2 mm were used. The shortest distance from the front end of each nozzle to the collector drum 26 was set to be 10 cm.

First, the stock solution for spinning (b1) was filled in the first syringe 32, and the catalyst liquid (c1) of Example 1 was filled in the second syringe 36. Further, the polymer electrolyte membrane (MA1) was wound on the collector drum 26.

While rotating the collector drum 26, by the high voltage power source 28, 10 kV DC voltage was applied between the nozzles 34 and 38 and the collector drum 26.

Having the syringe pump of the first syringe 32 operated, the stock solution for spinning (b1) was discharged from the nozzle 34 at 2.5 mL/hr to form fine fiber. The fiber was formed on the polymer electrolyte membrane (MA1) on the rotating collector drum 26 to form a nonwoven structure.

At the same time, having the syringe pump of the second syringe 36 operated, the catalyst liquid (c1) was discharged from the nozzle 38 at 2.5 mL/hr. The catalyst liquid (c1) was not formed into fiber but was adhered on the nonwoven structure and the polymer electrolyte membrane (MA1) on the collector drum in a form of particles. To the fiber constituting the nonwoven structure, particles of the catalyst were adhered.

Accordingly, by spraying the catalyst liquid (c1) onto the nonwoven structure formed on the polymer electrolyte membrane (MA1), a catalyst layer (B1) was formed, and a membrane/catalyst layer assembly (MC2) was obtained.

The average fiber diameter of the fiber constituting the nonwoven structure was 3 μm. Fiber having a fiber length of at most 3 mm was not observed.

The thickness of the catalyst layer (B1) was 40 μm, and the bulk density was 0.33 g/cc. The platinum amount per unit area of the catalyst layer (B1) was 0.4 mg/cm².

### Example 3

### Preparation of Gas Diffusion Layer (GDL1)

By using 200 μm of a high diffusion carbon paper (tradename: GDL25BC, sold by SGL Carbon Japan Co., Ltd.) provided with a microporous layer coating, a nonwoven structure was formed thereon to produce a gas diffusion layer (DGL1)/catalyst layer assembly.

### Formation of Catalyst Layer (C1):

The nonwoven structure production apparatus 30 as shown in FIG. 4 was prepared. As the nozzle 34 and the nozzle 38, injection needles having an inner diameter of 0.8 mm and an outer diameter of 1.2 mm were used. The shortest distance from the front end of each nozzle to the collector drum 26 was set to be 10 cm.

First, the stock solution for spinning (a1) of Example 1 was filled in the first syringe 32, and the spinning stock solution (b1) of Example 2 was filled in the second syringe 36. Further, the above carbon paper for the gas diffusion layer was wound on the collector drum 26.

While rotating the collector drum 26, by the high voltage power source 28, 10 kV DC voltage was applied between the nozzle 34 and 38 and the collector drum 26.

Having the syringe pump of the first syringe 32 operated, the stock solution for spinning (a1) was discharged from the nozzle 34 at 2.5 mL/hr to form fine fiber.

At the same time, having the syringe pump of the second syringe 36 operated, the stock solution for spinning (b1) was discharged from the nozzle 38 at 2.5 mL/hr to form fine fiber.

By forming such two types of fiber on the carbon paper on the rotating collector drum 26 and forming them into a nonwoven structure, a catalyst layer (C1) was formed, whereby a cathode (CA1) made of the gas diffusion layer (DGL1)/catalyst layer assembly was obtained.

Further, an anode (AN1) was obtained in the same manner.

The average fiber diameter of the fiber constituting the nonwoven structure was 2 μm. Fiber having a fiber length of at most 2 mm was not observed.

The thickness of catalyst layer (C1) was 30 μm, and the bulk density was 0.37 g/cc. The platinum amount per unit area of the catalyst layer (C1) was 0.4 mg/cm².

### Production of Membrane/Electrode Assembly (MEA3):

The catalyst layer (C1) side of the anode (AN1) was faced to the electrolyte membrane side of the polymer electrolyte membrane (MA1) provided with an ETFE film, having a thickness of 30 μm in Example 1, and then by using a commercially available flat plate pressing apparatus, they were laminated under pressing conditions of a temperature of 130° C., a pressure of 3 MPa and a time of 5 minutes to obtain a membrane/anode assembly.

After the ETFE film was peeled off from the membrane/anode assembly, the electrolyte membrane side of the membrane/anode assembly and the catalyst layer (C1) side of the cathode (CA1) were faced to each other, and by using the commercially available flat plate pressing apparatus, they were laminated under pressing conditions of a temperature of 130° C., a pressure of 3 MPa and a time of 5 minutes to obtain a membrane/electrode assembly (MEA3).

The power generation performance of the membrane/electrode assembly (MEA3) was evaluated. The results are shown in Table 1.

### Example 4

### Preparation of Stock Solution for Spinning (a2)

Into a hermetically-sealable cylindrical polyethylene bottle (internal volumeL 100 cc), 4 g of platinum supported carbon (TEC36P42, manufactured by Tanaka Kikinzoku Kogyo K.K., platinum supporting ratio: 40 mass %) and 10.4 g of distilled water were added, followed by stirring, and 9.0 g of ethanol was further added thereto. Then, 6.99 g of the water/ethanol solution (solid content; 28.8 mass %) of the copolymer H(11) was added thereto. Further, ZrO₂ particles having a diameter of 5 mm were added thereto to occupy about 40 cc, and then the polyethylene bottle was rotated on the commercially available ball mill rotating table for 24 hours to obtain a catalyst liquid (a2).

### Formation of Catalyst Layer (A2):

The nonwoven structure production apparatus 20 as shown in FIG. 3 was prepared. However, instead of the syringe 22, the fiber spinning nozzle 50 as shown in FIG. 6 was used. As the outer nozzle 53, an injection needle having an inner diameter of 1.5 mm and an outer diameter of 2.0 mm was used. As the inner nozzle 54, an injection needle having an inner diameter of 0.25 mm and outer diameter of 0.5 mm was used. The shortest distance from the front end of the outer nozzle 53 to the collector drum 26 was set to 10 cm.

First, the polymer electrolyte membrane (MA1) of Example 1 was wound on the collector drum 26.

While rotating the collector drum 26, by the high voltage power source 28, 10 kV of a DC voltage was applied between the outer nozzle 53 and the collector drum 26. The syringe pump (not shown) was operated to discharge the PEO solution (d1) of Example 1 from the outer nozzle 53 at 1 mL/hr, and at the same time, the stock solution for spinning (a2) was discharged from the inner nozzle 54 at 1 mL/hr to form fine core-in-sheath fiber. The fiber was formed on the polymer electrolyte membrane (MA1) on the rotating collector drum 26 to form a nonwoven structure, whereby a catalyst layer (A2) was formed, and a membrane/catalyst layer assembly (MC4) was obtained.

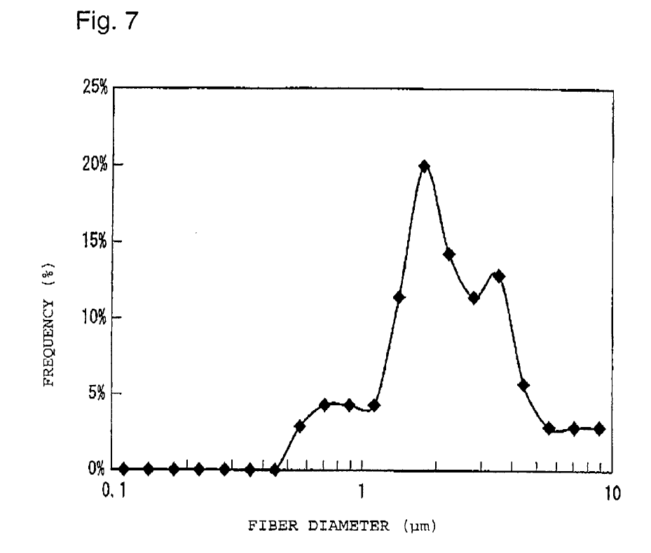

The fiber constituting the nonwoven structure had the fiber diameter distribution as shown in FIG. 7, and the average fiber diameter was 2 μm, Fiber having a fiber length of at most 2 mm was not observed.

The thickness of the catalyst layer (A2) was 30 μm, and the bulk density was 0.35 g/cc. The platinum amount per unit area of the catalyst layer (A2) was 0.1 mg/cm².

### Preparation of Gas Diffusion Layer (GDL2):

The above high diffusion carbon paper provided with a microporous layer coating (tradename: GDL25BC, sold by SGL Carbon Japan Co., Ltd.) was prepared and was used as a gas diffusion layer (GDL2).

### Production of Anode (AN2):

The catalyst liquid (c1) of Example 1 was diluted with a solvent mixture of water/ethanol (1/1 mass ratio) so that the solid content became 12 mass %, and in the same manner as in Example 1, the resultant was stirred by a ball mill for 24 hours to obtain a coating liquid for forming a catalyst layer.

On the above microporous layer (MPL) of the carbon paper for a gas diffusion layer, the coating liquid for forming a catalyst layer was cast by a die coat method, followed by drying at 80° C. for 30 minutes to form a catalyst layer, whereby an anode (AN2) was obtained.

### Production of Membrane/Electrode Assembly (MEA4):

After the ETFE film was peeled off from the membrane/catalyst layer assembly (MC4), the catalyst layer (A2) side of the membrane/catalyst layer assembly (MC4) and the MPL side of the above carbon paper for a gas diffusion layer were bonded to each other, and the electrolyte membrane side of the membrane/catalyst layer assembly (MC4) and the catalyst layer side of the anode (AN2) were bonded to each other to obtain a membrane/electrode assembly (MEA4).

The power generation performance of the membrane/electrode assembly (MEA4) was evaluated. The result is shown in Table 1.

### Example 5

### Preparation of Stock Solution for Spinning (b2)

To 50 g of the water/ethanol solution (solid content: 28.8 mass %) of the copolymer H(11), 1.5 g of the PEO solution (d1) of Example 1 was added, whereby a stock solution for spinning (b2) was obtained.

### Formation of Catalyst Layer (A3):

The nonwoven structure production apparatus used in Example 4 was prepared.

First, the polymer electrolyte membrane (MA1) of Example 1 was wound on the collector drum 26.

While rotating the collector drum 26, by the high voltage power source 28, a DC voltage of 10 kV was applied between the outer nozzle 53 and the collector drum 26. By having the syringe pump operated, the stock solution for spinning (b2) was discharge from the outer nozzle 53 at 1 mL/hr, and simultaneously, the stock solution for spinning (a2) of Example 4 was discharged from the inner nozzle 54 at 1 mL/hr to form fine core-in-sheath fiber, The fiber was formed on the polymer electrolyte membrane (MA1) on the rotating collector drum 26 and was formed into a nonwoven structure to form a catalyst layer (A3), whereby a membrane/catalyst layer assembly (MC5) was obtained.

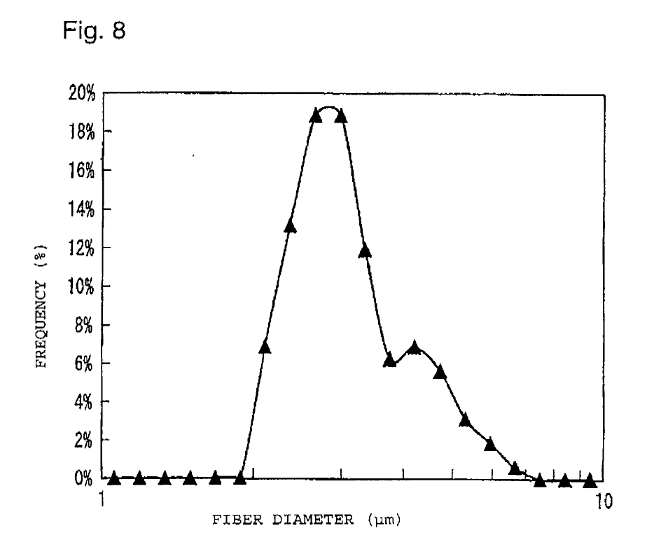

The fiber constituting the nonwoven structure had the fiber diameter distribution as shown in FIG. 8, and its average fiber diameter was 3 mm. Fiber having a fiber length of at most 3 mm was not observed.

The thickness of the catalyst layer (A3) was 90 μm, and the bulk density was 0.11 g/cc. The platinum of the catalyst layer (A3) per unit area was 0.18 mg/cm².

### Preparation of Gas Diffusion Layer (GDL3):

A carbon nonwoven structure for a gas diffusion layer (H2315T10a, manufactured by NOK Corporation, no MPL layer) was prepared and used as a gas diffusion layer (GDL3).

### Preparation of Membrane/Electrode Assembly (MEA5):

After the ETFE film was peeled off from the membrane/catalyst layer assembly (MC5), the catalyst layer (A3) side of the membrane/catalyst layer assembly (MC5) and a carbon nonwoven structure for a gas diffusion layer, were bonded to each other, and the electrolyte membrane side of the membrane/catalyst layer assembly (MC5) and the catalyst layer side of the anode (AN2) of Example 4, were bonded to each other to obtain a is membrane/electrode assembly (MEA5).

The power generation performance of the membrane/electrode assembly (MEA5) was evaluated. The result is shown in Table 1.

### Example 6

The catalyst liquid (c1) of Example 1 was diluted with the solvent mixture of water/ethanol (1/1 mass ratio) so that the solid content became 12 mass %, and in the same manner as in Example 1, the resultant was stirred by a ball mill for 24 hours to obtain a coating liquid for forming a catalyst layer.

On an ETFE film (manufactured by Asahi Glass Company, Limited, thickness: 100 μm), the coating liquid for forming a catalyst layer was cast by a die coat method, followed by drying at 80° C. for 30 minutes to form a catalyst layer. The platinum amount per unit area of the catalyst layer was 0.4 mg/cm².

The catalyst layer and the polymer electrolyte membrane (MA1) of Example 1 were put together and laminated under pressing conditions of a temperature of 130° C. and a pressure of MPa to obtain a membrane/catalyst layer assembly. The bulk density of the catalyst layer was 1.2 g/cc.

After the ETFE film was peeled off from the membrane/catalyst layer assembly, the catalyst layer side of the membrane/catalyst layer assembly and the above high diffusion carbon paper provided with a microporous layer coat (tradename: GDL25BC, sold by SGL Carbon Japan Co., Ltd.) were bonded to each other, and the electrolyte membrane side of the membrane/catalyst layer assembly and the catalyst layer of the anode (AN2) were bonded to each other to obtain a membrane/electrode assembly (MEA6).

The power generation performance of the membrane/electrode assembly (MEA6) was evaluated, but with a current density of 1.2 A/cm², no power was generated.

TABLE 1
Output voltage with current density of 1.2 A/cm²

| | |
|---|---|
| Example 3 | 434 |
| Example 4 | 343 |
| Example 5 | 555 |
| Example 6 | — |

The electrode for a polymer electrolyte fuel cell and the membrane/electrode assembly of the present invention are useful as an electrode for a polymer electrolyte fuel cell and a membrane/electrode assembly which exhibit a high energy efficiency and a high output density performance under conditions of a low operation temperature, a high current density and a high gas utilization.

The entire disclosure of Japanese Patent Application No. 2007-321772 filed on Dec. 13, 2007 including specification, claims, drawings and summary is incorporated herein by reference in its entirety.

What is claimed is:

1. An electrode for a polymer electrolyte fuel cell having a catalyst layer, wherein the catalyst layer has a nonwoven structure of fiber containing an ion-exchangeable fluoropolymer and a catalyst, the fiber has a fiber diameter of from 0.1 to 30 μm, and the catalyst layer has a bulk density of from 0.1 to 1.1 g/cc.

2. The electrode for a polymer electrolyte fuel cell according to claim 1, wherein the ion-exchangeable fluoropolymer is a copolymer having repeating units based on tetrafluoroethylene and repeating units represented by the following formula (1): 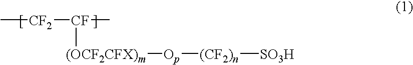
wherein X is a fluorine atom or a trifluoromethyl group, m is an integer of from 0 to 3, n is an integer of from 1 to 12, and p is 0 or 1.

3. The electrode for a polymer electrolyte fuel cell according to claim 2, wherein the ion-exchange capacity of the ion-exchangeable fluoropolymer is from 1.1 to 1.8 meq/g dry resin.

4. The electrode for a polymer electrolyte fuel cell according to claim 1, wherein the catalyst is a catalyst having platinum or a platinum alloy supported on a carbon carrier.

5. A membrane/electrode assembly for a polymer electrolyte fuel cell, comprising a cathode, an anode and a polymer electrolyte membrane disposed between them, wherein at least one of the cathode and anode is made of the electrode as defined in claim 1.

6. An electrode for a polymer electrolyte fuel cell, having a catalyst layer, wherein the catalyst layer has a nonwoven structure of fiber containing an ion-exchangeable fluoropolymer, and a catalyst adhered on the fiber, the fiber has a fiber diameter of from 0.1 to 30 μm, and the catalyst layer has a bulk density of from 0.1 to 1.1 g/cc.

7. The electrode for a polymer electrolyte fuel cell according to claim 6, wherein the ion-exchangeable fluoropolymer is a copolymer having repeating units based on tetrafluoroethylene and repeating units represented by the following formula (1): 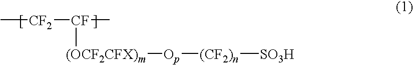
wherein X is a fluorine atom or a trifluoromethyl group, m is an integer of from 0 to 3, n is an integer of from 1 to 12, and p is 0 or 1.

8. The electrode for a polymer electrolyte fuel cell according to claim 7, wherein the ion-exchange capacity of the ion-exchangeable fluoropolymer is from 1.1 to 1.8 meq/g dry resin.

9. The electrode for a polymer electrolyte fuel cell according to claim 6, wherein the catalyst is a catalyst having platinum or a platinum alloy supported on a carbon carrier.

10. A membrane/electrode assembly for a polymer electrolyte fuel cell, comprising a cathode, an anode and a polymer electrolyte membrane disposed between them, wherein at least one of the cathode and anode is made of the electrode as defined in claim 6.

11. An electrode for a polymer electrolyte fuel cell, having a catalyst layer, wherein the catalyst layer has a nonwoven structure comprising fiber containing an ion-exchangeable fluoropolymer and a catalyst and fiber containing an ion-exchangeable polymer and no catalyst, the fiber has a fiber diameter of from 0.1 to 30 μm, and is the catalyst layer has a bulk density of from 0.1 to 1.1 g/cc.

12. The electrode for a polymer electrolyte fuel cell according to claim 11, wherein the ion-exchangeable fluoropolymer is a copolymer having repeating units based on tetrafluoroethylene and repeating units represented by the following formula (1): 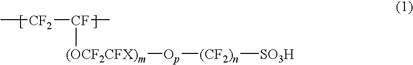
wherein X is a fluorine atom or a trifluoromethyl group, m is an integer of from 0 to 3, n is an integer of from 1 to 12, and p is 0 or 1.

13. The electrode for a polymer electrolyte fuel cell according to claim 12, wherein the ion-exchange capacity of the ion-exchangeable fluoropolymer is from 1.1 to 1.8 meq/g dry resin.

14. The electrode for a polymer electrolyte fuel cell according to claim 11, wherein the catalyst is a catalyst having platinum or a platinum alloy supported on a carbon carrier.

15. A membrane/electrode assembly for a polymer electrolyte fuel cell, comprising a cathode, an anode and a polymer electrolyte membrane disposed between them, wherein at least one of the cathode and anode is made of the electrode as defined in claim 11.

16. A process for producing a catalyst-containing nonwoven structure for a catalyst layer of an electrode for a polymer electrolyte fuel cell, which comprises producing a catalyst-containing nonwoven structure having a bulk density of from 0.1 to 1.1 g/cc and having fiber with a fiber diameter of from 0.1 to 30 μm gathered, from a fiber spinning stock solution containing an ion-exchangeable fluoropolymer and a catalyst, by an electrical field fiber spinning method.

17. The process according to claim 16, wherein the fiber spinning stock solution contains polyalkylene oxide or polyvinyl alcohol.

18. The process according to claim 16, wherein as the fiber spinning stock solution, n types (n is an integer of at least 2) of fiber spinning stock solutions are used, and when the fiber spinning stock solutions are spun into fiber by an electrical field fiber spinning method, the following fiber spinning nozzle is used;
a fiber spinning nozzle which has n flow paths, and one nozzle which discharges n types of fiber spinning solutions merged at the outlet end of the flow paths in a state of multiple layers.

19. The process according to claim 16, wherein as the fiber spinning stock solution, n types (n is an integer of at least 2) of fiber spinning stock solutions are used, and when the fiber spinning stock solutions are spun into fiber by an electrical field fiber spinning method, the following fiber spinning nozzle is used:
is a fiber spinning nozzle having multiple nozzles wherein n number of nozzles having different diameters are located concentrically to form a flow path between the adjacent nozzles.

20. The process according to claim 16, wherein the fiber is formed on a polymer electrolyte membrane.

21. The process according to claim 16, wherein fiber is formed on a sheet for a gas diffusion layer.

22. A process for producing a catalyst-containing nonwoven structure for a catalyst layer of an electrode for a polymer electrolyte fuel cell, which comprises producing a catalyst-containing nonwoven structure having a bulk density of from 0.1 to 1.1 g/cc and having fiber with a fiber diameter of from 0.1 to 30 μm gathered, from a fiber spinning stock solution containing an ion-exchangeable fluoropolymer, by an electrical field fiber spinning method, and letting a catalyst be supported on the nonwoven structure.

23. The process according to claim 22, wherein the fiber spinning stock solution contains polyalkylene oxide or polyvinyl alcohol.

24. The process according to claim 22, wherein as the fiber spinning stock solution, n types (n is an integer of at least 2) of fiber spinning stock solutions are used, and when the fiber spinning stock solutions are spun into fiber by an electrical field fiber spinning method, the following fiber spinning nozzle is used;
a fiber spinning nozzle which has n flow paths, and one nozzle which discharges n types of fiber spinning solutions merged at the outlet end of the flow paths in a state of multiple layers.

25. The process according claim 22, wherein as the fiber spinning stock solution, n types (n is an integer of at least 2) of fiber spinning stock solutions are used, and when the fiber spinning stock solutions are spun into fiber by an electrical field fiber spinning method, the following fiber spinning nozzle is used:
a fiber spinning nozzle having multiple nozzles wherein n number of nozzles having different diameters are located concentrically to form a flow path between the adjacent nozzles.

26. The process according to claim 22, wherein the fiber is formed on a polymer electrolyte membrane.

27. The process according to claim 22, wherein fiber is formed on a sheet for a gas diffusion layer.

28. A process for producing a catalyst-containing nonwoven structure for a catalyst layer of an electrode for a polymer electrolyte fuel cell, which comprises producing a catalyst-containing nonwoven structure having a bulk density of from 0.1 to 1.1 g/cc and having each fiber with a fiber diameter of from 0.1 to 30 μm gathered, by fiber-spinning from each of a fiber spinning stock solution containing an ion-exchangeable fluoropolymer and a catalyst and a fiber spinning stock solution containing an ion-exchangeable fluoropolymer and no catalyst, by an electrical field fiber spinning method.

29. The process according to claim 28, wherein the fiber spinning stock solution contains polyalkylene oxide or polyvinyl alcohol.

30. The process according to claim 28, wherein as the fiber spinning stock solution, n types (n is an integer of at least 2) of fiber spinning stock solutions are used, and when the fiber spinning stock solutions are spun into fiber by an electrical field fiber spinning method, the following fiber spinning nozzle is used:
a fiber spinning nozzle which has n flow paths, and one nozzle which discharges n types of fiber spinning solutions merged at the outlet end of the flow paths in a state of multiple layers.

31. The process according to claim 28, wherein as the fiber spinning stock solution, n types (n is an integer of at least 2) of fiber spinning stock solutions are used, and when the fiber spinning stock solutions are spun into fiber by an electrical field fiber spinning method, the following fiber spinning nozzle is used:
a fiber spinning nozzle having multiple nozzles wherein n number of nozzles having different diameters are located concentrically to form a flow path between the adjacent nozzles.

32. The process according to claim 28, wherein the fiber is formed on a polymer electrolyte membrane.

33. The process according to claim 28, wherein fiber is formed on a sheet for a gas diffusion layer.
